(19) United States
(12) Patent Application Publication
(10) Pub. No.: US 2006/0075447 A1
(43) Pub. Date: Apr. 6, 2006

(54) TV terminal embedded communication apparatus, and communication method

(76) Inventors: Nobuhiko Arashin, Osaka (JP); Tomonori Shiomi, Osaka (JP); Akihiro Tatsuta, Kyoto (JP); Osamu Tanaka, Osaka (JP); Hiroyuki Watanabe, Osaka (JP); Masahiko Nagoshi, Osaka (JP)

Correspondence Address: RATNERPRESTIA, P.O. BOX 980, VALLEY FORGE, PA, 19482, US

(21) Appl. No.: 11/240,285

(22) Filed: Sep. 30, 2005

(30) Foreign Application Priority Data
Oct. 1, 2004 (JP) 2004-290791

(51) Int. Cl. H04N 7/173; H04N 7/16; H04N 5/44

(52) U.S. Cl. 725/100; 348/725; 725/131; 725/151

(57) ABSTRACT

The present invention provides a TV terminal embedded communication apparatus, which has a shape compliant with predetermined existing standard dimensions of a type of TV terminal set on a wall surface, including a TV antenna terminal connectable to a TV antenna terminal of an existing TV terminal connected to a coaxial cable connected to a TV antenna, a communication connector terminal, a coaxial communication processing function section connected to the TV antenna terminal and having a coaxial communication function, a connector communication processing function section connected to the communication connector terminal and having a communication connector communication processing function and a data transfer function section that transfers data between the coaxial communication processing function section and the connector communication processing function section, and can construct a high-speed home network without removing the existing TV antenna terminal.

### FIELD OF THE INVENTION

The present invention relates to a TV terminal embedded communication apparatus having a coaxial communication processing function, and communication method.

### RELATED ART OF THE INVENTION

There has been an apparatus with a TV terminal provided with a slot-in type slot terminal to facilitate addition of components in accordance with changes in communication modes in recent years (see Japanese Patent Application No. 11-328625 (Japanese Patent Laid-Open No. 2001-119646)).

The disclosure of Japanese Patent Application No. 11-328625 (Japanese Patent Laid-Open No. 2001-119646) is incorporated herein by reference in their entireties.

However, when a conventional apparatus is used, it is necessary to remove an existing TV terminal attached to a wall and attach an apparatus having a new TV terminal and slot terminal to the same place and discard the existing TV terminal.

Furthermore, as for a power supply method, work inside the wall must be done, which involves extra expenses associated with the work.

Furthermore, since its frequency band used is a low band, the conventional apparatus is not suitable for communication utilization situations requiring a large-capacity communication infrastructure in recent years.

In view of the above described problems of the conventional apparatus, it is an object of the present invention to provide a TV terminal embedded communication apparatus capable of setting a new communication apparatus without replacing any existing TV terminal, and communication method.

### SUMMARY OF THE INVENTION

The 1^{st} aspect of the present invention is a TV terminal embedded communication apparatus, which has a shape compliant with predetermined existing standard dimensions of a type of TV terminal set on a wall surface, comprising:

a TV antenna terminal connectable to a TV antenna terminal of an existing TV terminal connected to a coaxial cable connected to a TV antenna;

a communication connector terminal;

a coaxial communication processing function section connected to said connectable TV antenna terminal and having a coaxial communication function;

a connector communication processing function section connected to said communication connector terminal and having a communication connector communication processing function; and

a data transfer function section that transfers data between said coaxial communication processing function section and said connector communication processing function section.

The 2^{nd} aspect of the present invention is the TV terminal embedded communication apparatus according to the 1^{st} aspect of the present invention, wherein power for said TV terminal embedded communication apparatus is supplied from an apparatus connected to said TV antenna terminal or said communication connector terminal.

The 3^{rd} aspect of the present invention is the TV terminal embedded communication apparatus according to the 1^{st} aspect of the present invention, further comprising a power supply terminal for said TV terminal embedded communication apparatus.

The 4^{th} aspect of the present invention is the TV terminal embedded communication apparatus according to the 1^{st} aspect of the present invention, further comprising a battery section for said TV terminal embedded communication apparatus inside.

The 5^{th} aspect of the present invention is the TV terminal embedded communication apparatus according to the 4^{th} aspect of the present invention, further comprising a switch section that controls a power supply from said battery section.

The 6^{th} aspect of the present invention is the TV terminal embedded communication apparatus according to the 1^{st} aspect of the present invention, further comprising a display section that indicates that said coaxial communication processing function section has linked with said coaxial communication processing function section of a communication apparatus having said coaxial communication function installed in a different place.

The 7^{th} aspect of the present invention is a TV terminal embedded communication apparatus, which has a flexible part having a shape not compliant with predetermined existing standard dimensions of a type of TV terminal set on a wall surface, comprising:

a TV antenna terminal connectable to a TV antenna terminal of an existing TV terminal connected to a coaxial cable connected to a TV antenna;

a communication connector terminal;

a coaxial communication processing function section connected to said connectable TV antenna terminal and having a coaxial communication function;

a connector communication processing function section connected to said communication connector terminal and having a communication connector communication processing function; and

a data transfer function section that transfers data between said coaxial communication processing function section and said connector communication processing function section.

The 8^{th} aspect of the present invention is a communication method using a TV terminal embedded communication apparatus, which has a shape compliant with predetermined existing standard dimensions of a type of TV terminal set on a wall surface, comprising:

a coaxial communication processing step of performing coaxial communication processing on a TV antenna terminal of an existing TV terminal connected to a coaxial cable connected to a TV antenna by using a coaxial communication processing function section connected to a connectable TV antenna terminal and having a coaxial communication function;

a communication processing step of performing communication processing by using a connector communication processing function section connected to a communication connector terminal and having a communication connector communication processing function; and

a data transfer step of performing a data transfer by using a data transfer function section that transfers data between said coaxial communication processing function section and said connector communication processing function section.

The 9^{th} aspect of the present invention is a communication method using a TV terminal embedded communication apparatus, which has a shape not compliant with predetermined existing standard dimensions of a type of TV terminal set on a wall surface, comprising:

a coaxial communication processing step of performing coaxial communication processing on a TV antenna terminal of an existing TV terminal connected to a coaxial cable connected to a TV antenna by using a coaxial communication processing function section connected to a TV antenna terminal having a connectable and flexible part and having a coaxial communication function;

a communication processing step of performing communication processing by using a connector communication processing function section connected to a communication connector terminal and having a communication connector communication processing function; and

a data transfer step of performing a data transfer by using a data transfer function section that transfers data between said coaxial communication processing function section and said connector communication processing function section.

Having the above described features, the TV terminal embedded communication apparatus according to the present invention can easily construct a high-speed home network environment by only fitting the TV terminal embedded communication apparatus into an existing TV terminal at home.

Furthermore, the present invention can eliminate the installation space for a coaxial communication apparatus which is required to install a conventional coaxial communication apparatus.

Furthermore, supplying power from the apparatus connected to terminals of the TV terminal embedded communication apparatus to the TV terminal embedded communication apparatus eliminates the power supply work on the back side (inside the wall surface) of the TV terminal.

Furthermore, even when there is no function of supplying power to the apparatus connected to the terminals, incorporating a power supply terminal in the TV terminal embedded communication apparatus allows power to be supplied to the TV terminal embedded communication apparatus.

Furthermore, the provision of a battery section allows power to be supplied to the TV terminal embedded communication apparatus even when devices connected to the respective terminals do not have any power supply function or there is no power supply environment near the wall surface or inside the wall surface, etc.

Furthermore, the provision of a switch function allows efficient use of the power supply of the battery section.

Furthermore, the provision of the link discrimination function allows the behavior of the TV terminal embedded communication apparatus to be visually easily determined, making it possible to cope with trouble, etc.

Furthermore, regardless of predetermined standard dimensions, the present invention is connectable to all types of existing TV terminals.

### BRIEF DESCRIPTION OF THE DRAWINGS

FIG. 1 is a configuration diagram of an existing TV terminal according to Embodiment 1 of the present invention;

FIG. 2 shows a TV terminal embedded communication apparatus according to Embodiment 1 of the present invention and an existing TV terminal with a cover removed;

FIG. 3 shows a side view and rear view of the TV terminal embedded communication apparatus according to Embodiment 1 of the present invention;

FIG. 4 is a configuration diagram when a video and a communication apparatus are connected to a TV terminal embedded communication apparatus according to Embodiment 2 of the present invention;

FIG. 5 is a configuration diagram of a TV terminal embedded communication apparatus according to Embodiment 3 of the present invention provided with a power socket;

FIG. 6 is a configuration diagram when the TV terminal embedded communication apparatus provided with a power socket according to Embodiment 3 of the present invention and an existing power receptacle are connected via a power cable;

FIG. 7 shows a side view and rear view of a TV terminal embedded communication apparatus having a battery section according to Embodiment 4 of the present invention;

FIGS. 8(A) and 8(B) are respectively configuration diagrams of a TV terminal embedded communication apparatus having a switch function and a TV terminal embedded communication apparatus having a link discrimination function according to Embodiments 5 and 6 of the present invention;

FIG. 9 is a structure diagram according to Embodiments 1 to 6 of the present invention;

FIG. 10 is an electrical circuit diagram according to Embodiments 1 to 6 of the present invention; and

FIG. 11 is a configuration diagram of a TV terminal embedded communication apparatus illustrating Embodiment 7 of the present invention.

### DESCRIPTION OF SYMBOLS

1 Existing TV terminal

2 TV terminal embedded communication apparatus

3 TV antenna terminal of TV terminal embedded communication apparatus

4 Communication connector of TV terminal embedded communication apparatus

5 Cover of existing TV terminal

6 TV antenna terminal of existing TV terminal

7 Lug holder of existing TV terminal

8 Existing TV terminal with cover removed

9 Coaxial communication processing function section of TV terminal embedded communication apparatus

10 Communication connector communication processing function section of TV terminal embedded communication apparatus

11 Data transfer function section of TV terminal embedded communication apparatus

12 TV antenna terminal of TV terminal embedded communication apparatus connected to TV antenna terminal of existing TV terminal

13 Lug of TV terminal embedded communication apparatus

14 Video

15 Coaxial cable

16 Communication cable

17 Communication apparatus

18 Power socket

19 Existing power receptacle

20 Power cable

21 Battery section of TV terminal embedded communication apparatus

22 Switch function section of TV terminal embedded communication apparatus

23 Link display section of TV terminal embedded communication apparatus

24 TV terminal embedded communication apparatus not compliant with predetermined standard dimensions

25 Back-side TV terminal of TV terminal embedded communication apparatus not compliant with predetermined standard dimensions

100 Coaxial cable

101 Distributor

102 Antenna

200 Wall

### PREFERRED EMBODIMENTS OF THE INVENTION

With reference now to the attached drawings, embodiments of the present invention will be explained below.

### Embodiment 1

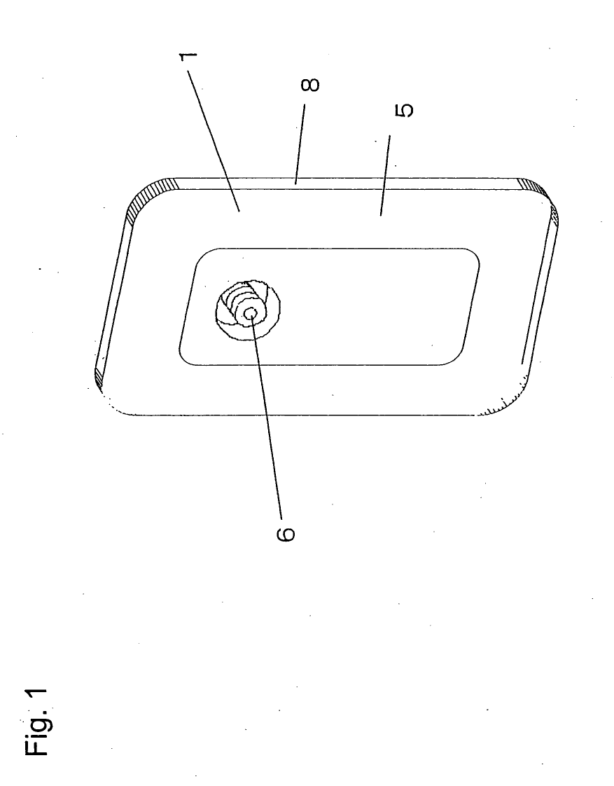

FIGS. 1 to 3, FIG. 9 and FIG. 10 will show a configuration diagram of Embodiment 1 of the present invention.

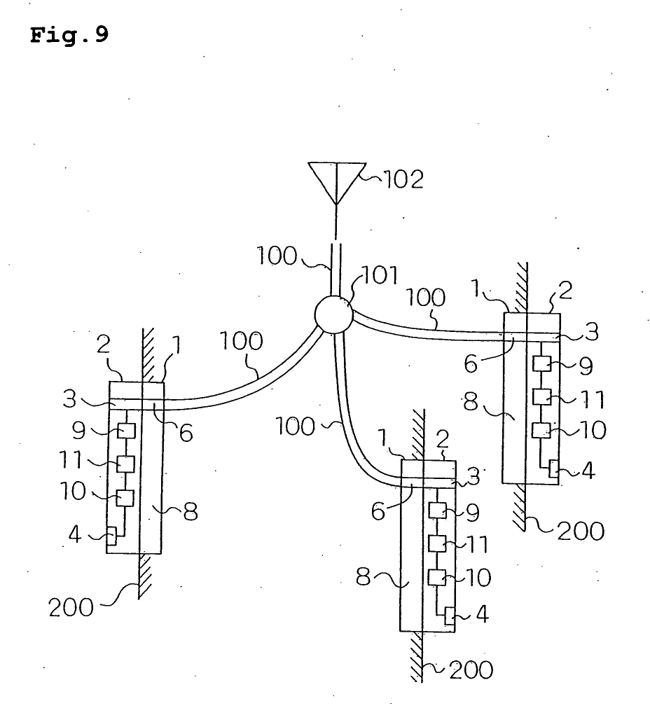

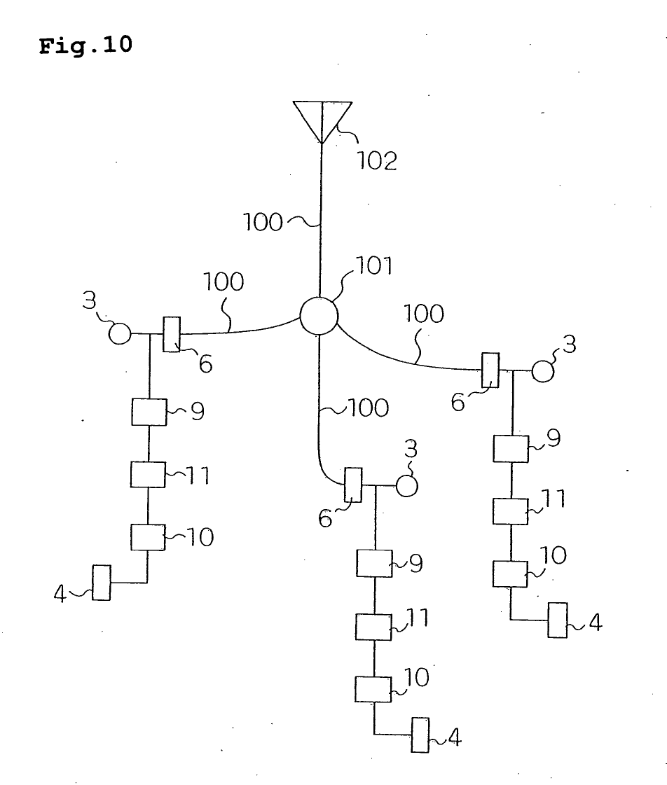

A TV terminal embedded communication apparatus 2 has the same size and shape as those of a TV terminal 1 compliant with existing predetermined home standard dimensions. The existing TV terminal 1 is, as shown in FIG. 1, constructed of a cover 5 and a TV terminal body 8. FIG. 9 shows an overall hardware configuration and FIG. 10 shows an overall electrical circuit configuration. Reference numeral 100 denotes a coaxial cable and 200 denotes a wall.

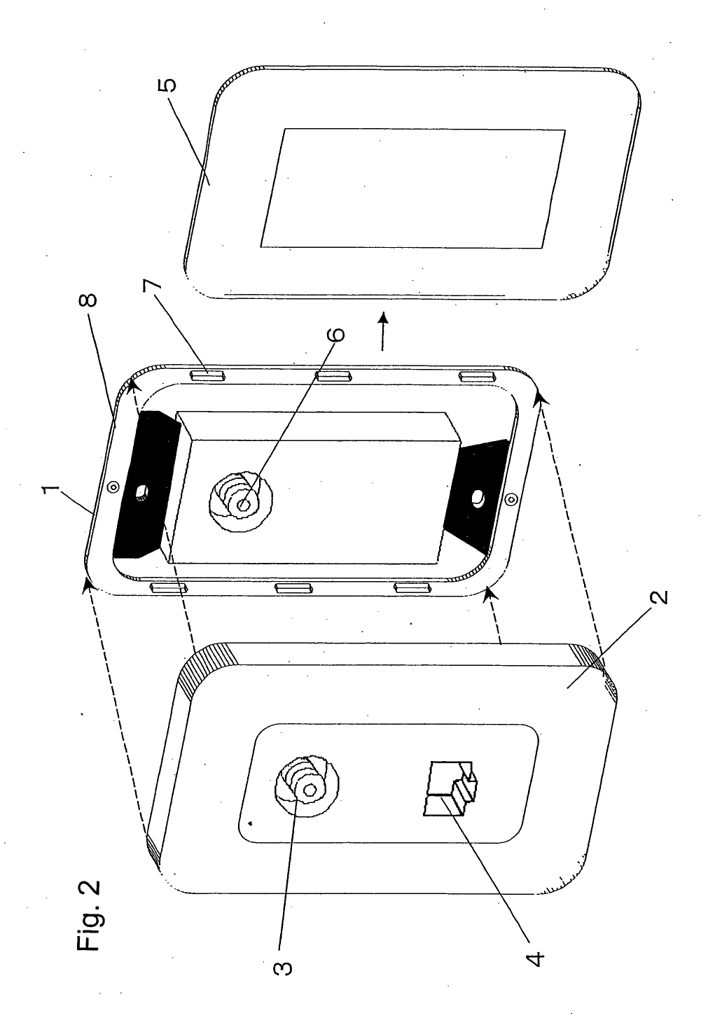

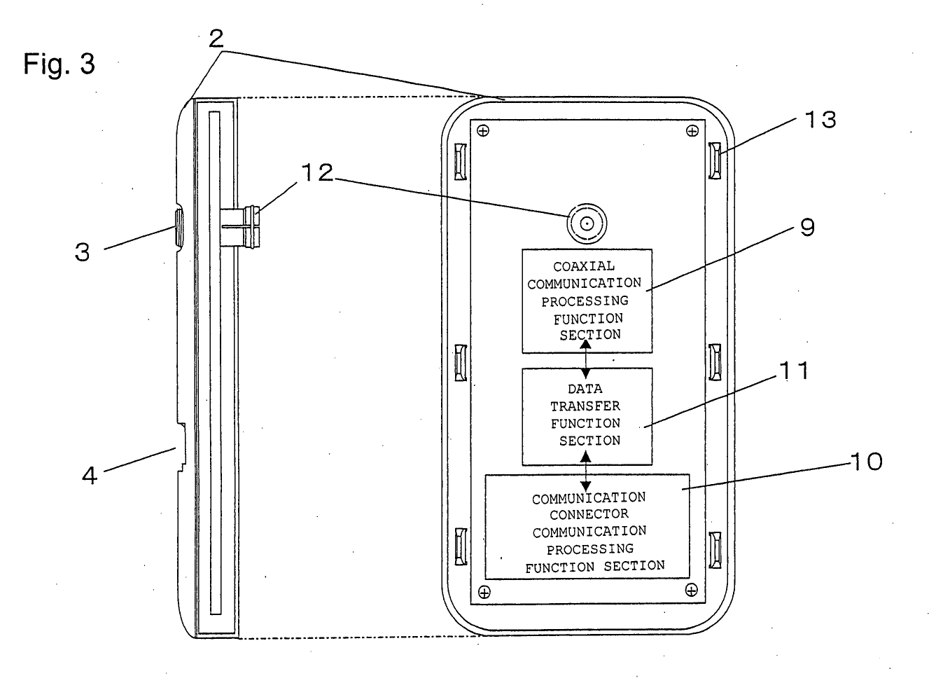

Furthermore, as show in FIG. 2 and FIG. 3, the TV terminal embedded communication apparatus 2 has a TV antenna terminal 3, a communication connector 4, a coaxial communication processing function section 9, a communication connector communication processing function section 10 and a data transfer function section 11.

Furthermore, as shown in FIG. 9 and FIG. 10, the coaxial cable 100 led from an antenna 102 is connected to various existing TV antenna terminals 6 through a distributor 101 and the TV antenna terminal 6 is further connected to the TV antenna terminal 3 of Embodiment 1 as will be explained below.

Furthermore, the coaxial communication processing function section 9 is connected to the TV antenna terminals 3, 6, and at the same time filters a high-frequency component, extracts a communication signal and sends it to the data transfer function section 11. The data transfer function section 11 sends the transmitted data to the communication connector communication processing function section 10. The communication connector communication processing function section 10 sends the data to an apparatus connected to a LAN, etc., connected to the communication connector 4.

On the contrary, the data sent from the apparatus connected to the communication connector 4 is sent to the communication connector 4, communication connector communication processing function section 10, data transfer function section 11 and coaxial communication processing function section 9 in that order. The coaxial communication processing function section 9 sends data to other TV terminal embedded communication apparatuses 2 through the coaxial cable 100 and communicates with them.

The procedure for attaching the TV terminal embedded communication apparatus 2 to the existing TV terminal 1 is as follows:

1. As shown in FIG. 2, the cover 5 of the existing TV terminal 1 is removed.

2. As shown in FIG. 2 and FIG. 3, the TV antenna terminals 3 and 12 of the TV terminal embedded communication apparatus 2 is fitted into the existing TV antenna terminal 6.

3. As shown in FIG. 2 and FIG. 3, a lug 13 of the TV terminal embedded communication apparatus 2 is engaged with a lug holder 7 of the existing TV terminal 1.

Since the TV terminal embedded communication apparatus 2 has a shape compliant with standard dimensions, the lug 13 can be engaged with the lug holder 7 of the TV terminal body 8 with the cover 5 of the existing TV terminal 1 removed.

Furthermore, as shown in FIG. 9 and FIG. 10, by installing the TV terminal embedded communication apparatuses 2 in the existing TV terminals 1 located in different places in the same way as the above described procedure, it is possible to construct a high-speed home network environment using coaxial cables 100 among the existing TV terminals.

It goes without saying that the communication apparatuses having the coaxial communication function located in the different places need not always be the TV terminal embedded communication apparatuses 2 according to the present invention if the communication apparatuses installed have a coaxial communication function.

Furthermore, by fitting the TV terminal embedded communication apparatus 2 into the existing TV terminal 1, it is possible to omit the installation space necessary to install the coaxial communication apparatus.

### Embodiment 2

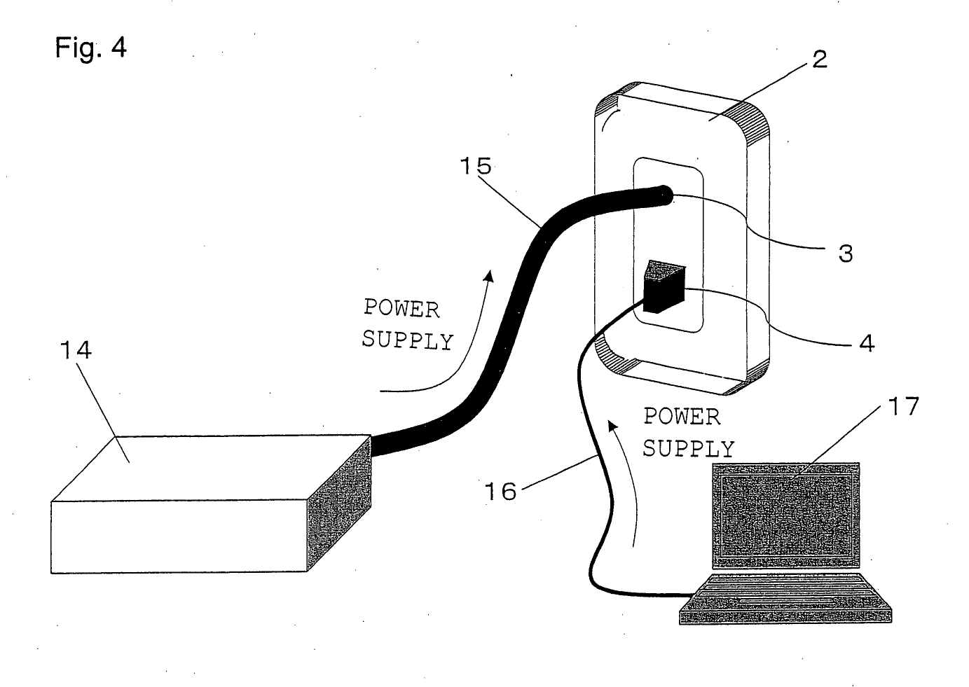

FIG. 4 shows a configuration diagram of Embodiment 2 of the present invention.

The following explanations will be provided assuming that a TV terminal embedded communication apparatus 2 is fitted in an existing TV terminal 1 using the installation method according to Embodiment 1.

A video 14 is connected to a TV antenna terminal 3 of the TV terminal embedded communication apparatus 2 via a coaxial cable 15. Moreover, this connected video 14 is provided with a function of supplying power to an antenna.

Here, the connected apparatus is assumed to be the video 14, but it goes without saying that any apparatus can be used if it is at least provided with the function of supplying power to the antenna.

Power is supplied to the TV terminal embedded communication apparatus 2 using the function of supplying power from the video 14 connected to the own TV antenna terminal 3 to the antenna.

Supplying power for the TV terminal embedded communication apparatus 2 from the connected video 14 to the own TV antenna terminal 3 eliminates the necessity for the work of supplying power inside the wall surface which has been conventionally required, producing no installation cost.

The case where the apparatus is connected to the TV antenna terminal 3 has been described above, but if a communication apparatus 17 whose communication cable 16 is connected to a communication connector 4 of the TV terminal embedded communication apparatus 2 has a power supply function, it is also possible to supply power from the communication apparatus 17 to the TV terminal embedded communication apparatus 2.

In this case, not only the power supply work becomes unnecessary but also power can be used more efficiently because power is supplied to the TV terminal embedded communication apparatus 2 only when power to the communication apparatus 17 connected to the communication connector 4 is on (that is, only when a network environment is used).

### Embodiment 3

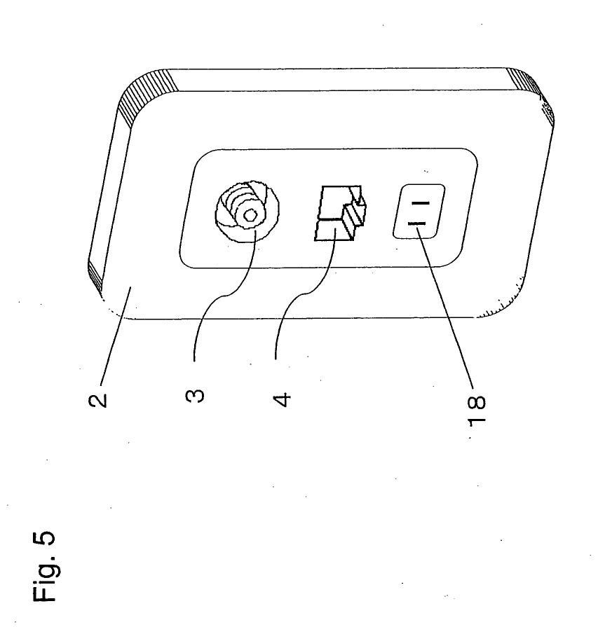

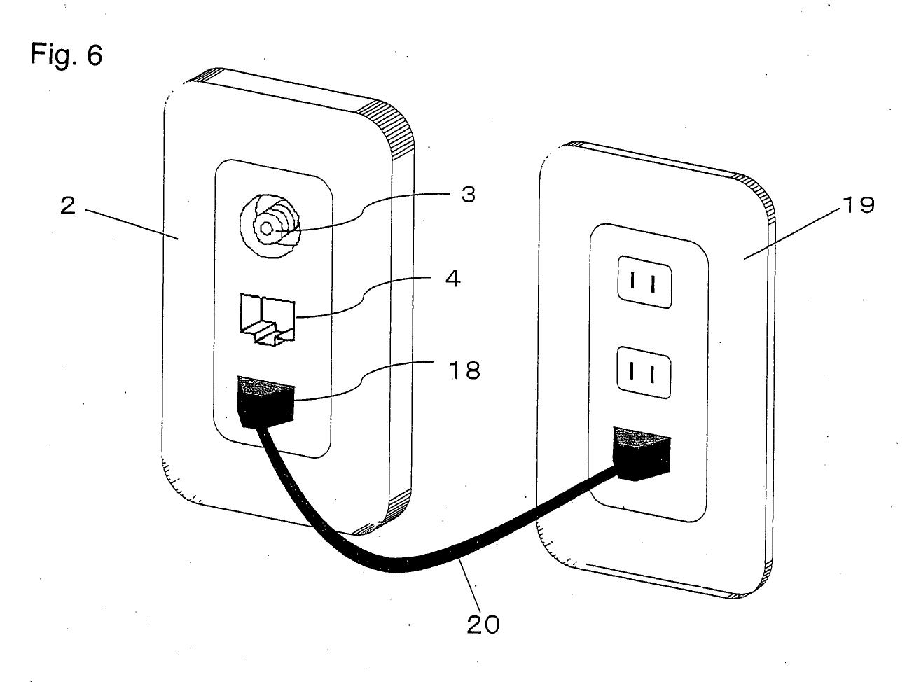

FIG. 5 and FIG. 6 show a configuration diagram according to Embodiment 3 of the present invention.

The following explanation will be provided assuming that a TV terminal embedded communication apparatus 2 is fitted in an existing TV terminal 1 using the setting method according to Embodiment 1.

The TV terminal embedded communication apparatus 2 shown in FIG. 5 has a power socket 18 and power is supplied to the TV terminal embedded communication apparatus 2 by connecting a power cord 20 from an existing power receptacle 19.

By connecting the power cord 20 from the existing power receptacle 19 to the power socket 18 of the TV terminal embedded communication apparatus 2, it is possible to supply power to the TV terminal embedded communication apparatus 2 and supply power to the TV terminal embedded communication apparatus 2 without executing any power supply work inside the wall surface. As a result, even when a communication apparatus connected to the TV terminal embedded communication apparatus 2 has no power supply function, it is possible to supply power to the TV terminal embedded communication apparatus 2.

Here, the case where the TV terminal embedded communication apparatus 2 has the power socket 18 has been described, but it goes without saying that any terminal (for example, power jack) can be used if it can at least supply power to the TV terminal embedded communication apparatus 2.

### Embodiment 4

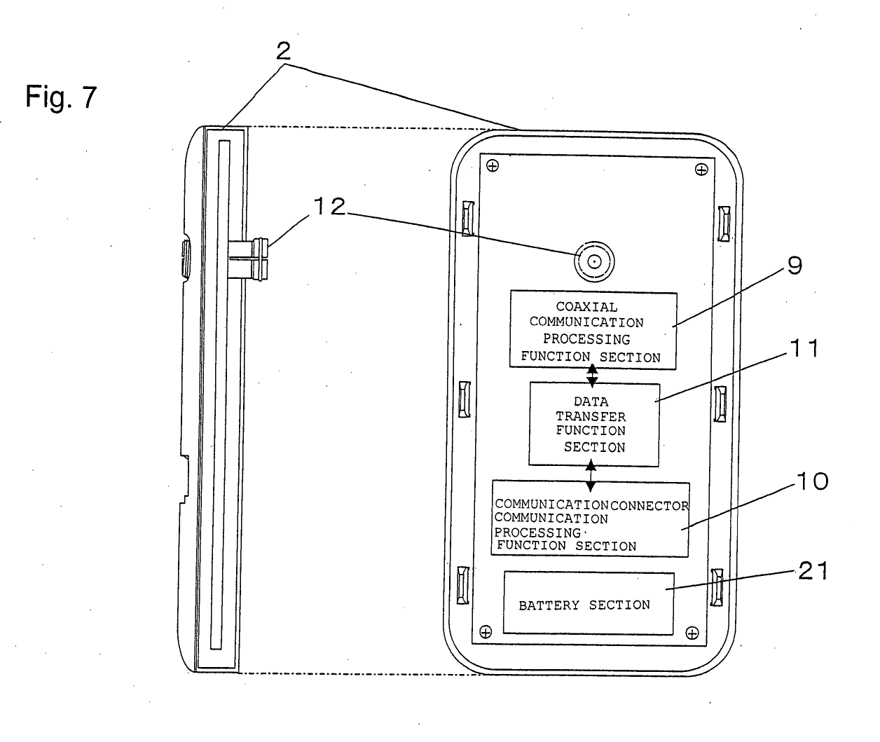

FIG. 7 shows a configuration diagram according to Embodiment 4 of the present invention.

The following explanation will be provided assuming that a TV terminal embedded communication apparatus 2 is fitted in an existing TV terminal 1 using the setting method according to Embodiment 1.

The TV terminal embedded communication apparatus 2 shown in FIG. 7 has a battery section 21 and power is supplied to the TV terminal embedded communication apparatus 2 from the battery section 21.

By supplying power from the own battery section 21, it is possible to supply power to the TV terminal embedded communication apparatus 2 even when there is no power receptacle 19 near the existing TV terminal 1 or a device connected to each terminal has no power supply function. Furthermore, by supplying power from the battery section 21, it is possible to supply power to the TV terminal embedded communication apparatus 2 without executing any power supply work inside the wall surface.

It goes without saying that the battery section 21 can be any battery such as a dry cell or battery with a charging function if it can at least supply power.

### Embodiment 5

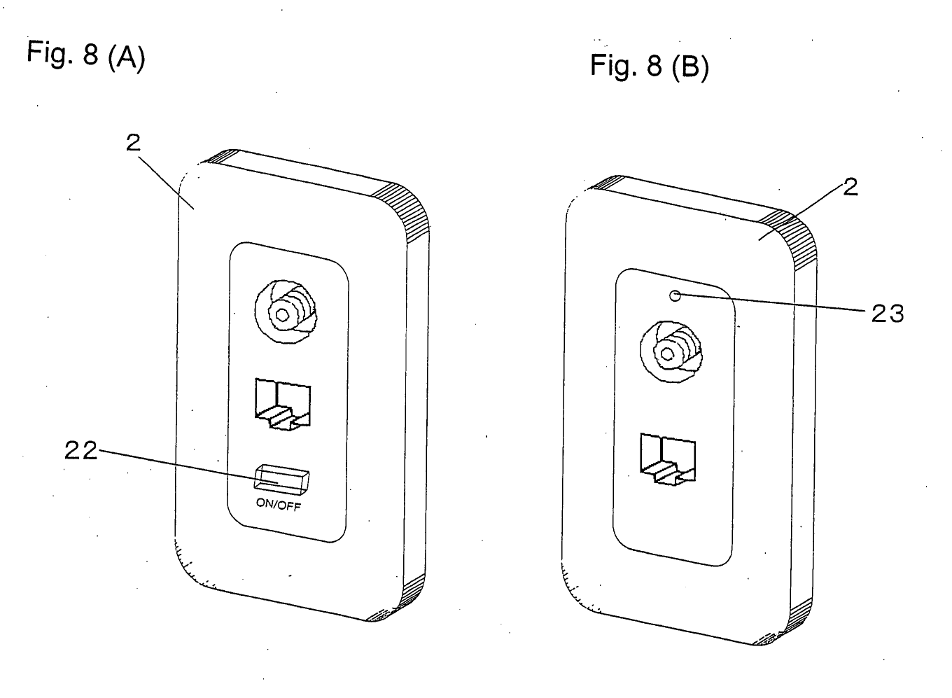

FIG. 8(A) shows a configuration diagram of Embodiment 5 of the present invention.

The following explanation will be provided assuming that a TV terminal embedded communication apparatus 2 having a battery section 21 is fitted in an existing TV terminal 1 using the setting method according to Embodiment 4.

The TV terminal embedded communication apparatus 2 shown in FIG. 8 has a switch function section 22 of turning ON/OFF a power supply to the TV terminal embedded communication apparatus 2 in the modes explained in Embodiments 2, 3, 4.

Having the switch function section 22 allows a power supply to the TV terminal embedded communication apparatus 2 to be controlled, and therefore by setting the switch function section 22 to ON when a coaxial communication function is used and setting the switch function section 22 to OFF when the coaxial communication function is not used, it is possible to use the power supply to the TV terminal embedded communication apparatus 2 efficiently.

### Embodiment 6

FIG. 8(B) shows a configuration diagram according to Embodiment 6 of the present invention.

The following explanation will be provided assuming that a TV terminal embedded communication apparatus 2 is fitted in an existing TV terminal 1 using the setting method according to Embodiment 1.

The TV terminal embedded communication apparatus 2 shown in FIG. 8 has a function of deciding whether a coaxial communication processing function section 9 has linked with a coaxial communication apparatus installed in a different place or not and displaying the result on an LED 23 which is an example of the display section of the present invention. The LED 23 is turned ON when the coaxial communication processing function section 9 is linked and the LED 23 is not turned ON when the coaxial communication processing function section 9 is not linked. Such discrimination is made by the coaxial communication processing function section 9.

Having such link displaying means allows the behavior of the TV terminal embedded communication apparatus 2 to be visually easily decided, and therefore it is possible to cope with trouble, etc.

Note that the link discrimination means is assumed to turn ON/OFF the LED 23, but it goes without saying that any other method can be used if it at least makes it possible to distinguish whether linkage is made or not.

### Embodiment 7

Next, Embodiment 7 of the present invention will be explained. A TV terminal embedded communication apparatus 24 according to this Embodiment 7 is constructed to be connectable to an existing TV terminal 1 even when it is not compliant with predetermined standard dimensions of the existing TV terminal 1.

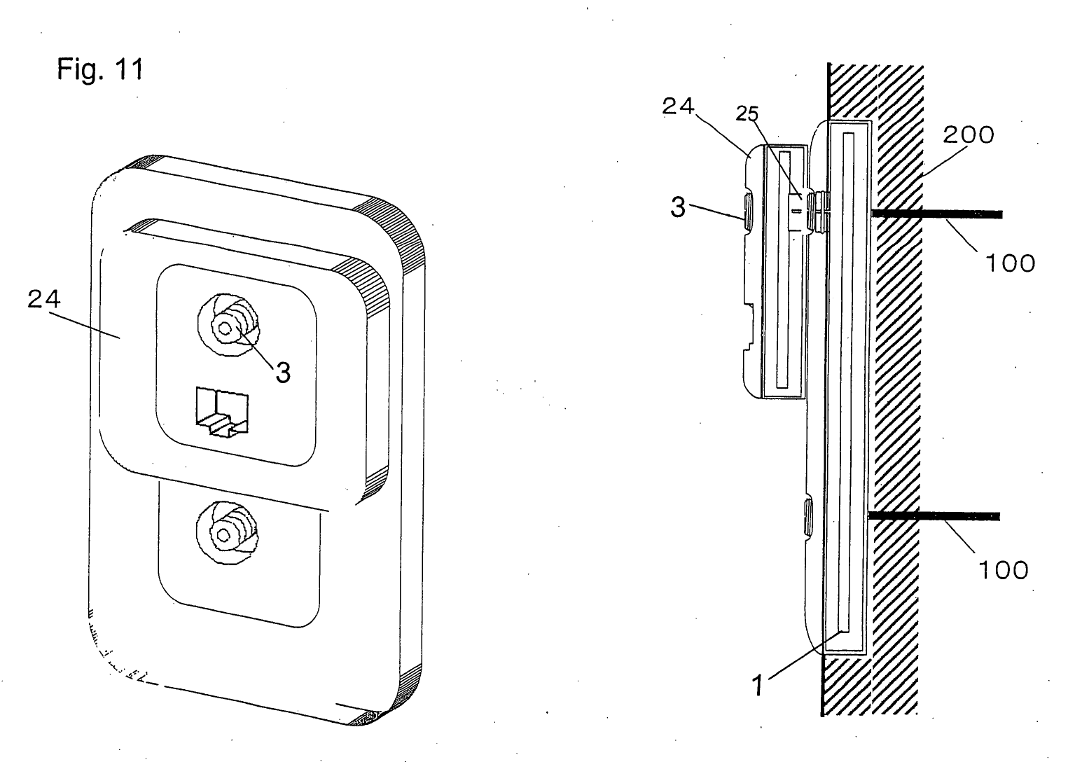

That is, as shown in FIG. 11, though this TV terminal embedded communication apparatus 24 has a TV antenna terminal 3, a communication connector 4, a coaxial communication processing function section 9, a communication connector communication processing function section 10, a data transfer function section 11 and a flexible back side TV antenna terminal 25, it is installed in a way in which only the flexible back side TV antenna terminal 25 is connected to the existing TV antenna terminal 6.

That is, as shown in FIG. 11, a TV terminal embedded communication apparatus 24 not compliant with predetermined standard dimensions and an existing TV terminal 1 are connected together only through the back side TV antenna terminal 25 of the TV terminal embedded communication apparatus 24 and the existing TV antenna terminal 6 without removing a cover 5 of the existing TV terminal 1. This is useful when there are a plurality of existing TV antenna terminals 6.

The method of connecting the TV terminal embedded communication apparatus 2 not compliant with predetermined standard dimensions according to this Embodiment 7 to the existing TV terminal 1 is not particularly limited; the TV terminal embedded communication apparatus 2 may be installed with the cover 5 of the existing TV terminal 1 removed if at least the TV antenna terminal 12 of the TV terminal embedded communication apparatus 2 is connected to the TV antenna terminal 6 of the existing TV terminal. It goes without saying that any shape or dimensions different from those of the existing TV terminal 1 may also be acceptable.

The TV terminal embedded communication apparatus 2 not compliant with predetermined standard dimensions can be connectable to all types of TV terminal 1.

Embodiments 1 to 7 have been explained so far, but the type of the communication connector (for example, IEEE1394, D terminal, USB, etc.) does not matter in the present invention. Furthermore, it goes without saying that the TV terminal embedded communication apparatus may be provided with a plurality of TV antenna terminals and a plurality of communication connectors. Furthermore, the place where the TV terminal is installed has been assumed to be a home but it goes without saying that the place may be anywhere.

The present invention is applicable to construction of a high-speed home network using an existing TV terminal.

1. A TV terminal embedded communication apparatus, which has a shape compliant with predetermined existing standard dimensions of a type of TV terminal set on a wall surface, comprising:
a TV antenna terminal connectable to a TV antenna terminal of an existing TV terminal connected to a coaxial cable connected to a TV antenna;
a communication connector terminal;
a coaxial communication processing function section connected to said connectable TV antenna terminal and having a coaxial communication function;
a connector communication processing function section connected to said communication connector terminal and having a communication connector communication processing function; and
a data transfer function section that transfers data between said coaxial communication processing function section and said connector communication processing function section.

2. The TV terminal embedded communication apparatus according to claim 1, wherein power for said TV terminal embedded communication apparatus is supplied from an apparatus connected to said TV antenna terminal or said communication connector terminal.

3. The TV terminal embedded communication apparatus according to claim 1, further comprising a power supply terminal for said TV terminal embedded communication apparatus.

4. The TV terminal embedded communication apparatus according to claim 1, further comprising a battery section for said TV terminal embedded communication apparatus inside.

5. The TV terminal embedded communication apparatus according to claim 4, further comprising a switch section that controls a power supply from said battery section.

6. The TV terminal embedded communication apparatus according to claim 1, further comprising a display section that indicates that said coaxial communication processing function section has linked with said coaxial communication processing function section of a communication apparatus having said coaxial communication function installed in a different place.

7. A TV terminal embedded communication apparatus, which has a flexible part having a shape not compliant with predetermined existing standard dimensions of a type of TV terminal set on a wall surface, comprising:
a TV antenna terminal connectable to a TV antenna terminal of an existing TV terminal connected to a coaxial cable connected to a TV antenna;
a communication connector terminal;
a coaxial communication processing function section connected to said connectable TV antenna terminal and having a coaxial communication function;
a connector communication processing function section connected to said communication connector terminal and having a communication connector communication processing function; and
a data transfer function section that transfers data between said coaxial communication processing function section and said connector communication processing function section.

8. A communication method using a TV terminal embedded communication apparatus, which has a shape compliant with predetermined existing standard dimensions of a type of TV terminal set on a wall surface, comprising:
a coaxial communication processing step of performing coaxial communication processing on a TV antenna terminal of an existing TV terminal connected to a coaxial cable connected to a TV antenna by using a coaxial communication processing function section connected to a connectable TV antenna terminal and having a coaxial communication function;
a communication processing step of performing communication processing by using a connector communication processing function section connected to a communication connector terminal and having a communication connector communication processing function; and
a data transfer step of performing a data transfer by using a data transfer function section that transfers data between said coaxial communication processing function section and said connector communication processing function section.

9. A communication method using a TV terminal embedded communication apparatus, which has a shape not compliant with predetermined existing standard dimensions of a type of TV terminal set on a wall surface, comprising:
a coaxial communication processing step of performing coaxial communication processing on a TV antenna terminal of an existing TV terminal connected to a coaxial cable connected to a TV antenna by using a coaxial communication processing function section connected to a TV antenna terminal having a connectable and flexible part and having a coaxial communication function;
a communication processing step of performing communication processing by using a connector communication processing function section connected to a communication connector terminal and having a communication connector communication processing function; and
a data transfer step of performing a data transfer by using a data transfer function section that transfers data between said coaxial communication processing function section and said connector communication processing function section.
a data transfer step of performing a data transfer by using a data transfer function section that transfers data between said coaxial communication processing function section and said connector communication processing function section.
